(19) United States
(12) Patent Application Publication
(10) Pub. No.: US 2010/0003363 A1
(43) Pub. Date: Jan. 7, 2010

(54) Method of improving poultry production

(75) Inventors: Carl J. Knueven, Bowling Green, OH (US); John S. Pitts, Weatherford, TX (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Jones-Hamilton Co.

(21) Appl. No.: 12/217,418

(22) Filed: Jul. 3, 2008

(51) Int. Cl. A23K 1/175

(52) U.S. Cl. 426/2; 426/656

(57) ABSTRACT

A method of improving a feed conversion ratio in poultry includes feeding to the poultry a poultry feed including an amount of an inorganic acid which is effective to improve the feed conversion ratio. A method of controlling microorganisms in poultry includes feeding to the poultry a poultry feed including an amount of an inorganic acid which is effective to control microorganisms in the poultry. A method of decreasing ammonia released from poultry manure includes feeding to the poultry a poultry feed including an amount of an inorganic acid which is effective to decrease the amount of ammonia released from the poultry manure.

### BACKGROUND OF THE INVENTION

This invention relates in general to poultry production and in particular to a method of increasing feed efficiency and improving other aspects of poultry production.

Current commercial-scale poultry raising operations house the poultry in confined spaces. Feed and water is made available to the chicks so they can mature into adult birds which typically are intended as a food source. Generally, these are high volume facilities, and efficiency and cost control are extremely important. While the majority of these operations are for chicken production, other poultry can be included, such as turkey, ducks, geese and less common poultry as well.

Enhancing growth or feed efficiency of the poultry can substantially improve the profitability of poultry production. The feed conversion ratio (FCR) is the ratio of the amount of feed consumed relative to the weight gain of the poultry. A low FCR indicates that a given amount of feed results in the poultry gaining proportionately more weight. This means that the poultry is able to utilize the feed more efficiently.

Healthy poultry often grow faster or are more able to convert their feed efficiently into body tissue than sick poultry. For this and other reasons it is desirable to control bacteria and other microorganisms in the poultry. One approach to improving feed efficiency is to give the poultry antibiotic growth promoters.

The number one complaint filed with environmental agencies against poultry producers involves odors. Controlling odors associated with poultry excreta is a continuing problem for poultry and egg producers. Aerosol ammonia is one of the primary causes of nuisance odors associated with confined poultry feeding operations. In addition to ammonia's role as a component in nuisance odors, high levels of gaseous ammonia may adversely affect poultry health and the safety of people working in these environments.

It would be desirable to provide a method of improving poultry production in areas such as feed conversion ratio, microorganism control, and/or reduction in ammonia emissions.

### SUMMARY OF THE INVENTION

This invention relates to a method of improving a feed conversion ratio in poultry which comprises feeding to the poultry a poultry feed including an amount of an inorganic acid which is effective to improve the feed conversion ratio.

In another embodiment, the invention relates to a method of controlling microorganisms in poultry which comprises feeding to the poultry a poultry feed including an amount of an inorganic acid which is effective to control microorganisms in the poultry.

In a further embodiment, the invention relates to a method of decreasing ammonia in poultry manure which comprises feeding to the poultry a poultry feed including an amount of an inorganic acid which is effective to decrease the amount of ammonia released from the poultry manure.

Various aspects of this invention will become apparent to those skilled in the art from the following detailed description of the preferred embodiment.

### DETAILED DESCRIPTION OF THE PREFERRED EMBODIMENT

A method of improving the feed conversion ratio in poultry according to the invention includes feeding to the poultry a poultry feed including an amount of an inorganic acid which is effective to improve the feed conversion ratio. As mentioned above, the feed conversion ratio (FCR) is the ratio of the weight of feed consumed relative to the weight gain of the poultry over a certain period of time. A lower FCR indicates a more efficient utilization of feed and is thus an improvement over a higher FCR.

The inorganic acid included in the poultry feed can be any type which is suitable for improving the feed conversion ratio. Mixtures of different inorganic acids can also be used. In some embodiments, the inorganic acid has a pKₐ from about 1 to about 5. Nonlimiting examples of inorganic acids include alkali metal bisulfates, phosphoric acid, hydrochloric acid, sulfuric acid, sulfurous acid and sulfamic acid. In some particular embodiments, the inorganic acid is a dry acid.

In some embodiments, the inorganic acid is an alkali metal bisulfate or a mixture of different alkali metal bisulfates. For example, the alkali metal bisulfate can be selected from sodium bisulfate, potassium bisulfate, or a mixture thereof. Sodium bisulfate is a sodium salt of sulfuric acid generally expressed as NaHSO₄ (CAS Reg. No. 7681-38-1). It is also known as sodium acid sulfate, sodium hydrogen sulfate, and bisulfate of soda.

An example of a sodium bisulfate that can be used is a feed grade sodium bisulfate manufactured by Jones-Hamilton Co., 30354 Tracy Road, Walbridge, Ohio 43465. It is approved by the FDA as a feed ingredient and is listed as a “General Purpose Feed Additive” with no restrictions in the Official Publication of the Association of American Feed Control Officials. It has been certified as GRAS (Generally Recognized As Safe), and it meets Food Chemicals Codex, 5^{th} Edition Specifications. This sodium bisulfate is described in more detail in U.S. Pat. Nos. 5,707,658; 5,773,063; 5,958,491; 6,132,792; 6,620,445; 7,048,803; and 7,097,861 which are all incorporated by reference herein.

The Jones-Hamilton sodium acid sulfate is a dry product comprising crystalline solid particles. In one embodiment, the product has a moisture content (measured by loss on drying) of less than 0.8%, although other moisture contents may also be suitable. In one embodiment, the particles have a generally spherical shape with an average diameter of from about 0.03 mm to about 1 mm, and typically about 0.75 mm. However, other shapes and sizes of particles may also be suitable.

In one embodiment, the Jones-Hamilton sodium acid sulfate product includes sodium bisulfate in an amount of from about 91.5% to about 97.5% by weight (typically about 93%), and sodium sulfate in an amount of from about 2.5% to about 8.5% by weight (typically about 7%). However, the product could have any suitable composition. In one embodiment, the sodium acid sulfate product is low in impurities, containing less than 0.003% heavy metals as lead, less than about 0.05% water-insoluble substances, and/or less than 0.003% selenium (all measured by weight percent), although products containing different levels of impurities may also be suitable in some applications.

The potassium bisulfate for use in the poultry feed is a potassium salt of sulfuric acid generally expressed as KHSO₄ (CAS Reg. No. 7646-93-7). It is also known as potassium acid sulfate and potassium hydrogen sulfate.

The inclusion of an inorganic acid in the poultry feed includes not only an acid per se, but may also include any other material(s) that are converted to an inorganic acid after having been fed to the poultry.

The inorganic acid is included in the poultry feed in any amount which is effective to improve the feed conversion ratio. In some embodiments, the inorganic acid is included in an amount from about 0.1% to about 3% by weight of the poultry feed, more particularly from about 0.1% to about 1%, and most particularly particularly from about 0.25% to about 0.75%. However, in other embodiments other amounts of inorganic acid may be suitable.

In addition to the inorganic acid, the poultry feed includes any other ingredients suitable for use in a poultry feed. The poultry feed is formulated and produced to be fed specifically to poultry. In some embodiments, the poultry feed is formulated to meet or exceed National Research Council guidelines for the nutritional requirements of poultry (see Nutrition Requirements of Poultry, 9^{th} edition, National Academy Press, Washington, D.C. (1994)). These nutritional requirements are disclosed in charts for different types of poultry in U.S. Patent Application Publication No. 2006/0045907 A1, published Mar. 2, 2006, which charts are incorporated by reference herein.

The poultry feed includes one or more sources of protein. The protein source(s) can include proteins of vegetable origin, such as soybean meal, full-fat soybeans, corn gluten, coconut oil meal, cottonseed meal, guar meal, linseed oil meal, peanut meal, rapeseed oil meal, safflower meal, sesame meal, and sunflower seed meal. The protein source(s) can also include proteins of animal origin, such as dried blood, dried poultry waste, liver meal, meat by-products, for example, meat scraps and meat and bone meal, milk products, such as dried skim milk, dried butter milk, and dried whey, poultry by-products, such as hydrolyzed poultry feather meal, and poultry hatchery by-product meal, for example eggshells, unhatched and infertile eggs, and culled chicks. The protein source(s) can further include proteins of fish origin, such as white fish meal, dark fish meal, and shrimp meal.

The poultry feed also includes one or more sources of carbohydrates. The carbohydrate source(s) can include, for example, barley, buckwheat, cassava, corn, for example, yellow corn, white corn or high-lysine corn, millet, molasses, oats, rice, rye, sorghums, for example, kafir and milo, triticale, wheat, mill by-products such as hominy feed, rice bran, and rice hulls, and wheat by-products such as wheat bran and wheat millings.

The poultry feed may also include other suitable ingredients, for example, one or more fats and oils such as hard fats from slaughtered cattle, soft fats, for example, yellow grease, hydrolyzed animal fats, vegetable oils, and polyunsaturated fatty acids in egg yolks. The poultry feed may include one or more green leafy products, such as alfalfa products, for example, sun-cured alfalfa meal, dehydrated alfalfa meal, and dehydrated alfalfa leaf meal.

Other ingredients that may be suitable include, for example, macrominerals such as rock phosphate, dicalcium phosphate, bone meal, argonite, limestone, oyster shell, gypsum and salt. The poultry feed may include trace minerals such as calcium, phosphorus, sodium, chlorine, potassium, sulfur, iodine, fluorine, iron, copper, manganese, magnesium, selenium, vanadium, and zinc. The poultry feed may include vitamins such as fat-soluble vitamins, for example, vitamins A, D, E, and K, water-soluble vitamins, for example, vitamin C, thiamin, riboflavin, pantothenic acid, niacin, pyridoxine, choline, biotin, folacin, and B₁₂.

The poultry feed may further include any other suitable feed constituents, such as amino acids, antioxidants, electrolytes, pellet binders, tranquilizers and other supplements, for example, flavoring agents, enzymes, thyroactive compounds, and drugs.

The poultry feed can be provided in any suitable form, such as mash, pellets or crumbles, using any suitable manufacturing process and equipment. For example, the ingredients can be dry blended so that they are relatively uniformly distributed throughout the feed. Apparatus for dry blending such ingredients is well known to those skilled in the art. The blended ingredients can be ground to a small size but not to a powder to produce a mash, using any suitable grinding apparatus such as those known in the art. Alternatively, the mash can be compressed and formed into pellets using any suitable pelletizing equipment, such as those known in the art. The pellets can have any suitable size and shape. Alternatively, the pellets can be broken up into smaller pieces to make crumbles.

The poultry feed can be fed to the poultry using any feeding regimen that is effective to improve the feed conversion ratio. In some embodiments, the amount of feed and the percentage of inorganic acid in the feed are selected so that the inorganic acid is fed to the poultry in an amount from about 0.01 g to about 22 g per day, and more particularly from about 0.03 g to about 6 g per day. The amount will usually differ depending on the type of poultry. For example, chicken broilers may be fed so that they consume the inorganic in an amount from about 0.01 g to about 8 g per day, and more particularly from about 0.03 g to about 3 g per day. Turkeys may be fed so that they consume the inorganic acid in an amount from about 0.01 g to about 22 g per day, and more particularly from about 0.03 g to about 7 g per day.

Also, the poultry can be subjected to the feeding regimen for any suitable period of time. In some embodiments, the poultry feed is fed to chicken broilers during a period of at least about 35 days, more particularly at least about 40 days, and more particularly at least about 45 days. In some embodiments, the poultry feed is fed to turkeys during a period of at least about 70 days, more particularly at least about 100 days, and more particularly at least about 120 days. The days can be consecutive or nonconsecutive. During that feeding period, the poultry may consume the inorganic acid in an average amount per day such as described above.

The poultry feed can be fed to the poultry at any suitable time(s) during the growing stage of their lives. For example, when the poultry are chickens broilers, the poultry feed may be fed to the broilers during a period that occurs within their first nine weeks of life (from 0 to 56 days), which typically is their primary growing stage. Turkeys typically have a growing stage during their first 20 weeks of life (from 0 to 140 days).

The feeding of the poultry feed to the poultry can result in any suitable improvement in the feed conversion ratio. In some embodiments, feeding the poultry feed results in an improvement of at least about 1% in the feed conversion ratio during a 48 day period, more particularly at least about 3%, and more particularly at least about 10%, compared to feeding the same poultry feed without the inorganic acid (with the percentages of the other ingredients increased proportionately to make up for the removal of the acid).

The improvement in the feed conversion ratio can result in more weight gain by the poultry for a given amount of feed. In some embodiments, feeding the poultry feed results in an improvement of at least about 0.3% in the average daily weight gain of the poultry during the feeding period, more particularly at least about 1.5%, and more particularly at least about 2%, compared to feeding the same poultry feed without the inorganic acid.

In another embodiment, the invention relates to a method of controlling microorganisms in poultry which comprises feeding to the poultry a poultry feed including an amount an inorganic acid which is effective to control the microorganisms. By “control” is meant inhibiting the growth of detrimental microorganisms, promoting the growth of beneficial microorganisms and/or increasing the ratio of beneficial microorganisms to detrimental microorganisms. The microorganisms may include bacteria, fungi and/or microparasites. In a particular embodiment, the inorganic acid functions as a hind gut acidifier and thereby inhibits detrimental bacteria and promotes beneficial bacteria in the gut. However, the inorganic acid could have any other suitable microorganism controlling function(s).

The poultry feed and the amount of inorganic acid can be the same as described above, or they can be different, depending on the particular microorganisms, poultry and other circumstances. In one embodiment, the inorganic acid is sufficiently effective in controlling microorganisms so that the poultry feed does not need to include any other antibiotics.

The effectiveness of the poultry feed in controlling microorganisms in the poultry can be determined by any suitable method. For example, different methods of detecting levels of microorganisms in the blood, tissues and manure of poultry are known in the art.

In another embodiment, the invention relates to a method of decreasing ammonia released from poultry manure which comprises feeding to the poultry a poultry feed including an amount an inorganic acid which is effective to decrease the amount of ammonia released from the poultry manure.

The poultry feed and the amount of inorganic acid can be the same as described above, or they can be different, depending on the particular poultry, environment and other circumstances.

The amount of ammonia released from the poultry manure can be determined by any suitable method. In one embodiment, the ammonia released is measured by ammonia flux, which is the level of ammonia in the air immediately surrounding the manure. The ammonia flux can be measured by any suitable method. In one example, the ammonia flux is measured using the method described in a publication by D. M. Miles et al., entitled “Spatial Variability of Litter Gaseous Flux Within a Commercial Broiler House: Ammonia, Nitrous Oxide, Carbon Dioxide, and Methane”, Poultry Science, volume 85, pages 167-172 (2006), which is incorporated by reference herein. In the described method, the ammonia flux is measured using a photo-acoustic multigas analyzer (Innova 1312, California Analytical, Orange, Calif.) in conjunction with flux boxes. The flux boxes are cylindrical plastic containers, 35 cm high with a 14.3-cm radius, with a small electric fan mounted inside the bottom of each container. The analyzer is connected to the flux box by a 0.635-cm diameter tube with a length of 1.07 m. Approximately 2 seconds before the analyzer draws in a sample (time-zero concentration), the flux box is inverted on the litter surface. The second sample is captured after 70 seconds. The difference between the concentrations at time zero and 70 seconds is used to determine the ammonia flux. The fan mixes the air in the flux box for 10 seconds before the second measurement is taken. The poultry house dimensions are 12.8 m×146.3 m. The house contains approximately 26,700 broiler chicks. Thirty-six sampling positions compose an imaginary grid where measurements are placed at 3 locations across the house (5 meters apart) and 12 locations down the house (12 meters apart). The ammonia flux is the average of the 36 measurements.

The ammonia released from the poultry manure can be decreased by any suitable amount. In one embodiment, the ammonia is decreased by at least about 30% as measured by ammonia flux, more particularly by at least about 50%, and more particularly by at least about 70%, compared to feeding the same poultry feed without the inorganic acid. In one embodiment, the ammonia is decreased to a level not greater than about 4 mg NH₃/m² min as measured by ammonia flux, and more particularly not greater than about 3 mg.

### Experimental

Following is a synopsis of three experimental trials in which chickens were fed chicken feed that included sodium bisulfate (SBS).

Trial 1

This was a 44 day trial comparing chickens fed diets including 0.75% SBS with those fed control diets. Data of significance:

| | | Feed Conversion |
|---|---|---|
| | Body Weight Gain (lb) | (lb feed/lb body weight gain) |
| Control | 6.391 | 1.818 |
| 0.75% SBS | 6.554 | 1.798 |

Trial 2

This was a 28 day battery trial comparing 0.75% and 0.25% SBS diet inclusion to control. A battery is a stack of small cages used in preliminary research. Data of significance:

| | | Feed Conversion with |
|---|---|---|
| | Total Body Weight (lb) | Mortality Weights (lb) |
| Control | 2.81 | 1.52 |
| 0.75% SBS | 2.94 | 1.44 |
| 0.25% SBS | 2.95 | 1.45 |

With mortality weights means that birds that died or were removed from the trial and their estimated feed intake were subtracted from the totals.

Trial 3

This was a 28 day battery trial comparing 0.75% and 0.25% SBS diet inclusion to control exactly as trial 1. Data of significance:

| | | Feed Conversion with |
|---|---|---|
| | Total Body Weight (lb) | Mortality Weights (lb) |
| Control | 2.42 | 1.51 |
| 0.75% SBS | 2.51 | 1.49 |
| 0.25% SBS | 2.34 | 1.47 |

The data show that there is a trend toward greater body weights and better feed conversion with diets including sodium bisulfate, particularly at levels of 0.75%.

Trial 4

This was a 48 day floor pen trial comparing 0.75% and 0.25% SBS diet inclusion to control. Data of significance:

| | Body Weight Gain (lb) | Feed Conversion |
|---|---|---|
| Control | 6.581 | 1.84 |
| 0.75% SBS | 6.700 | 1.78 |
| 0.25% SBS | 6.704 | 1.79 |

In accordance with the provisions of the patent statutes, the principle and mode of operation of this invention have been described in its preferred embodiment. However, it must be understood that this invention may be practiced otherwise than as specifically described without departing from its spirit or scope.

What is claimed is:

1. A method of improving a feed conversion ratio in poultry which comprises feeding to the poultry a poultry feed including an amount of an inorganic acid which is effective to improve the feed conversion ratio.

2. The method of claim 1 wherein the inorganic acid comprises an alkali metal bisulfate.

3. The method of claim 1 wherein the poultry feed includes from about 0.1% to about 3% inorganic acid by weight of the poultry feed.

4. The method of claim 1 wherein feeding the poultry feed includes feeding the inorganic acid in an amount from about 0.01 g to about 22 g per day.

5. The method of claim 1 wherein feeding the poultry feed includes feeding the inorganic acid during a period of at least about 35 days.

6. The method of claim 1 wherein feeding the poultry feed results in an improvement of at least about 1% in the feed conversion ratio during a 48 day period, compared to feeding the same poultry feed without the inorganic acid.

7. The method of claim 1 wherein feeding the poultry feed is also effective to control microorganisms in the poultry.

8. The method of claim 1 wherein feeding the poultry feed is also effective to decrease ammonia released from manure of the poultry.

9. A method of controlling microorganisms in poultry which comprises feeding to the poultry a poultry feed including an amount an inorganic acid which is effective to control microorganisms in the poultry.

10. The method of claim 9 wherein the inorganic acid comprises an alkali metal bisulfate.

11. The method of claim 9 wherein the poultry feed includes from about 0.1% to about 3% inorganic acid by weight of the poultry feed.

12. A method of decreasing ammonia released from poultry manure which comprises feeding to the poultry a poultry feed including an amount an inorganic acid which is effective to decrease the amount of ammonia released from the poultry manure.

13. The method of claim 12 wherein the inorganic acid comprises an alkali metal bisulfate.

14. The method of claim 12 wherein the poultry feed includes from about 0.1% to about 3% inorganic acid by weight of the poultry feed.

15. The method of claim 12 wherein the ammonia is decreased by at least about 30% as measured by ammonia flux, compared to feeding the same poultry feed without the inorganic acid.

16. The method of claim 12 wherein the ammonia is decreased to a level not greater than about 4 mg NH₃/m² min as measured by ammonia flux.

17. A poultry feed which is formulated and produced to be fed specifically to poultry, the poultry feed comprising a source of protein, a source of carbohydrates, and an amount of an inorganic acid which is effective to improve a feed conversion ratio of the poultry.

18. The poultry feed of claim 17 wherein the inorganic acid comprises an alkali metal bisulfate.

19. The poultry feed of claim 17 which includes from about 0.1% to about 3% inorganic acid by weight of the poultry feed.

20. The poultry feed of claim 17 which is formulated to meet or exceed National Research Council guidelines for the nutritional requirements of poultry.

21. The poultry feed of claim 17 which is a chicken feed.
